(19) United States
(12) Patent Application Publication
(10) Pub. No.: US 2003/0223841 A1
(43) Pub. Date: Dec. 4, 2003

(54) Process for the releasable attachment of wearing parts in devices for treating suspended fiber stock

(75) Inventor: Werner Brettschneider, Ravensburg (DE)

Correspondence Address: GREENBLUM & BERNSTEIN, P.L.C., 1950 ROLAND CLARKE PLACE, RESTON, VA, 20191, US

(73) Assignee: Voith Paper Patent GmbH, Heidenheim (DE)

(21) Appl. No.: 10/446,875

(22) Filed: May 29, 2003

(30) Foreign Application Priority Data
May 31, 2002 (DE) DE 202 08 439.6

(51) Int. Cl. F16B 23/00

(52) U.S. Cl. 411/403

(57) ABSTRACT

Process and apparatus for the releasable attachment of wearing parts in devices for treating suspended fiber stock using screw elements with at least one threaded part and at least one turned part. The process includes transmitting a torsional force to the at least one turned part, which includes at least two recesses, which is sufficient to one of tighten or loosen the threaded part. The at least two recesses are sunk in a same direction as a screw in feed of the threaded part. The instant abstract is neither intended to define the invention disclosed in this specification nor intended to limit the scope of the invention in any way.

### CROSS-REFERENCE TO RELATED APPLICATIONS

The present application claims priority under 35 U.S.C. § 119 of German Patent Application No. 202 08 439.6, filed on May 31, 2002, the disclosure of which is expressly incorporated by reference herein in its entirety.

### BACKGROUND OF THE INVENTION

1. Field of the Invention

The invention relates to a process for the releasable attachment of wearing parts in devices for treating suspended fiber stock, in particular, recovered paper, using screw elements with at least one threaded part and at least one turned part. In this way, the turned part is used to transmit the torsional force necessary for tightening or loosening to the threaded part

2. Discussion of Background Information

During preparation of suspended fiber stock, the paper raw material, e.g., recovered paper, is mixed with water, crushed and cleaned of undesirable, non-fibrous constituents. The devices thereby used are subjected to a high degree of wear. The main reason for this is the high contaminants contained in the suspension, such as metal parts, stones, sand and broken glass. Certain important highly stressed components of such devices can be protected by replaceable wearing parts. This applies in particular to wires in pulpers, secondary pulpers and screens that are provided with bars on the stressed side. As a rule, the side to be protected is the side past which the scraper is moved. Other parts of pulpers, secondary pulpers, screens and pumps that are known to be particularly at risk for wear such as, e.g., their rotors or in cleaners (i.e., hydrocyclones) can also be protected by replaceable wearing parts.

The use of screw elements such as, e.g., screws, nuts or threaded bolts is the most widely used method to produce a releasable attachment. Such screw elements have long since proved to be worthwhile and have achieved a very high diversity by constant further development. In order to be able to accomplish the tightening and loosening of a screw connection, the screw element features a turned part, e.g., the screw head, to which turning tools, such as, e.g., spanners or screwdrivers, can be attached. Such turned parts thereby have, e.g., a hexagonal circumferential area or hexagonal recesses, slots or the like placed on the face surface.

One great advantage of screw elements is that they can be produced in large quantities because of the large number of their possible uses. Standard screws, which are used for most attachment methods, are particularly cost-effective. Only in exceptional cases are special screws used to produce releasable connections. It is known from British Application No. GB 2 082 709 A to produce screws with a flat, disk-shaped screw head, so that these screws can be used to be countersunk in beams. Thus, while are particularly aesthetic and can only be unscrewed with special spanners. Special screws with heads that feature grooves open to the edge are disclosed by utility model German Gebrauchsmuster No. DE 297 18 286 U1. These screws are preferably used to attach covers of a cable shaft let into the ground and should be resistant to soiling. Non-standardized screws are used particularly frequently in order to prevent the theft of parts by which they are attached. It is thereby assumed that potential thieves have only standard tools for loosening screws. German Patent No. DE 881 129 C and German Patent Application No. DE 20 33 556 A show examples of this.

A known problem is the gradual alteration of the turned parts belonging to the screw elements. Such an alteration occurs during the operation of the machines equipped with screw couplings, in particular, due to wear and corrosion. As a result a screw connection often can no longer be loosened or can be loosened only with great difficulty. For example, it often happens that the screw head, i.e., the part of a screw on which the turning tool should act, is so worn that the necessary torque to loosen the screw connection can no longer be transmitted. The mechanic can then be injured if the tool slips or skids. In order to be able to loosen the connection anyway, the screw has to be drilled out or ground off, which is expensive and can lead to damage of the machine parts. Although it is known that the hexagonal recess made in the face surface of a screw head (hexagonal socket screw) is somewhat better protected from wear than the screws with hexagonal raised area, in many applications the problem is still not thereby solved.

German Patent Application No. DE 100 65 930 describes a typical application of the invention where the screw fasteners of wearing parts are particularly at risk for wear. The screw-on bars described are used in a paper pulper or secondary pulper that is subjected to a high degree of wear as a result of the very contaminated recovered paper suspension treated therein. This wear can wear off a large part of the standard screw heads and then lead to the problem with loosening and retightening the screw connections.

### SUMMARY OF THE INVENTION

The present this invention provides an attachment method with which provision is made for the easy loosening of the connection to be possible even with advanced wear of the attachment parts.

Accordingly, the invention includes a turned part into which at least two recesses are sunk, and a lengthwise extension which lies essentially in a same direction as a screw in feed of a threaded part.

It is ensured by the described measures that, even if wear has already occurred, it is still possible to loosen or tighten the screw coupling, e.g., with a simple special connecting part. The suitable connecting part is provided with corresponding pins or projections that can be inserted into the mentioned recesses. Therefore, the necessary torsional moment must be produced via several spaced recesses and not, as before, via a single form-locked connection. The usual problems of blunting the profiles forming the form lock and of the tool slipping through or slipping off no longer arise. Shortening the recesses by wearing off a material surplus to be considered as wear reserve is not damaging. Changes in shape of the recesses, such as, e.g., a circular bore becoming oval, do not impair the function. The handling is nevertheless still very simple.

Screw elements according to the invention can possibly be produced very simply by modifying commercially available screws or nuts (standard parts) accordingly. Thus, e.g., the screw heads of flat-head screws can be provided with cylinder bores. In many cases, however, customized products with particular wear reserve (material surplus) are to be recommended.

The present invention is directed to a process for the releasable attachment of wearing parts in devices for treating suspended fiber stock using screw elements with at least one threaded part and at least one turned part. The process includes transmitting a torsional force to the at least one turned part, which includes at least two recesses, which is sufficient to one of tighten or loosen the threaded part. The at least two recesses are sunk in a same direction as a screw in feed of the threaded part.

According to a feature of the invention, the suspended fiber stock being treated is recovered paper.

Further, in accordance with the invention, at least three recesses can be sunk in the turned part.

In accordance with the invention, a free cross section of the recesses may be constant across at least 90% of a lengthwise extension of the recesses. The at least two recesses can completely penetrate the turned part.

According to another feature of the invention, the at least two recesses may be cylindrical bores arranged in a parallel manner.

Further, the at least two recesses can include a recess located in a center of the turned part and a recess not located in the center of the turned part.

The at least two recesses can include at least three recesses which are uniformly arranged on a circle lying concentric with the threaded part.

Moreover, the at least one threaded element may include a screw fastener and the turned part comprises a screw head.

According to still another feature of the invention, the at least one turned part may include a nut having a face in which the at least two recesses are sunk.

The process can also include machining one of a screw head or a face of a nut with the at least two recesses.

In accordance with another feature, the turned part can have a material surplus serving as a wear reserve, through which the at least two recesses extend. The material surplus may be produced such that an axial extension of the turned part is significantly larger with respect to the thread diameter than with corresponding standard parts. Further, a ratio of the axial extension of the turned part to the thread diameter is at least 0.6, and preferably at least 0.8.

According to a further feature of the present invention, the transmitting of torsional force may include coupling a connecting part to the at least one turned part. The connecting part can include at least two projections or pins structured and arranged to fit into the at least two recesses, and the transmission of torsional force can further include inserting the at least two projections or pins into the at least two recesses and applying a torque to the connecting part, whereby the turned part rotates. The connecting part may further include a locking profile structured and arranged to receive a screw turning tool, and the transmission of torsional force can further include coupling the screw turning tool to the locking profile and rotating the locking profile via the screw turning tool. Further, the connecting part may further include a locking profile structured and arranged to receive a lever, and the transmission of torsional force further comprises coupling the lever to the locking profile and rotating the locking profile via the lever.

Still further, the device for treating suspended fiber stock can include a pulper for recovered paper pulper.

Further still, the device for treating suspended fiber stock may include a secondary pulper connected downstream of a recovered paper pulper.

Moreover, the device for treating suspended fiber stock can include a screen for contaminated recovered paper suspension.

The present invention is directed to an apparatus for releasably attaching wearing parts in devices for treating suspended fiber stock. The apparatus includes at least one threaded part having a longitudinal axis and at least one turned part having at least two recesses that are sunk in a same direction as the longitudinal axis of the threaded part.

In accordance with a feature of the invention, the at least two recesses can include at least three recesses sunk in the turned part.

Further, a free cross section of the at least two recesses may be constant across at least 90% of a lengthwise extension of the at least two recesses. The at least two recesses can completely penetrate the turned part.

According to another feature of the present invention, the at least two recesses can include a recess located in a center of the turned part and a recess not located in the center of the turned part.

Moreover, the at least two recesses can include at least three recesses which are uniformly arranged on a circle lying concentric with the threaded part.

According to still another feature of the present invention, the at least one turned part may include a nut having a face in which the at least two recesses are sunk.

Still further, the turned part can have a material surplus serving as a wear reserve, through which the at least two recesses extend. A ratio of an axial extension of the turned part to a thread diameter of the threaded part is at least 0.6, and preferably is at least 0.8.

The apparatus can also include a connecting part structured and arranged to be coupled to the at least one turned part to transmit a torsional force to the at least one turned part. The connecting part can include at least two projections or pins structured and arranged to fit into the at least two recesses. Further, the connecting part can also include a locking profile structured and arranged to receive a screw turning tool, whereby a torsional force is transmitted to the at least one turning part via the screw turning tool. Moreover, the connecting part can include a locking profile structured and arranged to receive a lever, whereby a torsional force is transmitted to the at least one turning part via the lever.

The present invention is directed to an apparatus for treating suspended fiber stock. The apparatus includes a wire structured and arranged to pass treated stock, bars coupled to the wires, and a connection element structured and arranged to releasably attach the bars to the wire. The connection element has a longitudinal axis and a head having at least two recesses sunk in a same direction as the longitudinal axis.

According to a feature of the instant invention, the apparatus can be structured and arranged for treating suspended fiber stock as a pulper for recovered paper pulper.

Further, the apparatus may be structured and arranged for treating suspended fiber stock as a secondary pulper connected downstream of a recovered paper pulper.

Further still, the apparatus can be structured and arranged for treating suspended fiber stock for contaminated recovered paper suspension.

In accordance with another feature of the invention, the head can be mounted flush with a surface of the bars.

In accordance with still yet another feature of the present invention, the head may be structured to project from a surface of the bars.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a typical example of a connection produced in accordance with the present invention;

FIG. 2 illustrates a side view of a screw element used in accordance with the instant invention together with a suitable connecting part;

FIG. 3 illustrates a top view of the elements depicted in FIG. 2;

FIG. 4 illustrates a variant of screw element having a flat-head screw;

FIG. 5 illustrates a side view of another variant of the invention;

FIG. 6 illustrates a top view of the parts variant depicted in FIG. 5.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

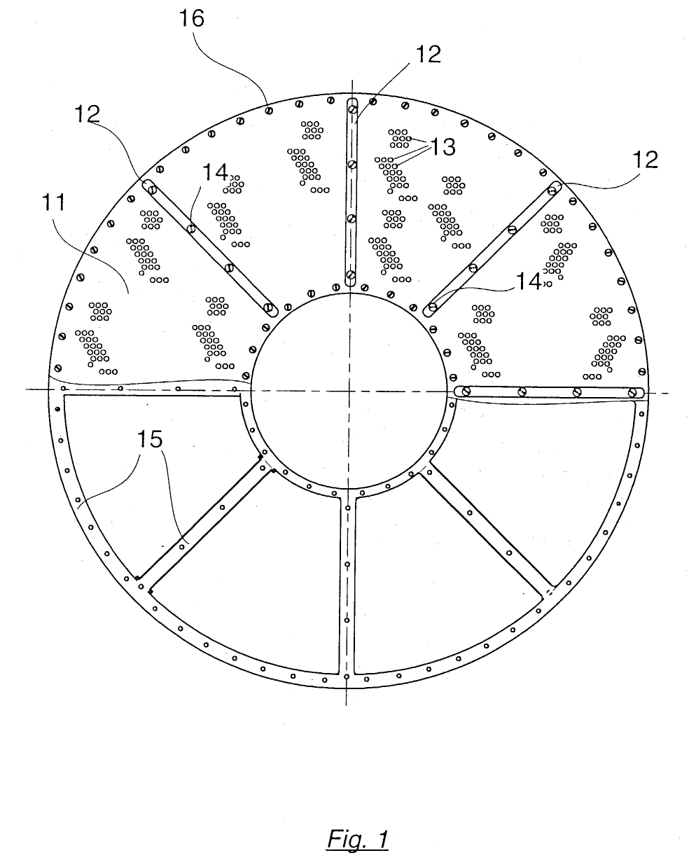

FIG. 1 shows the wire area of a secondary pulper for recovered paper preparation, which wire area is used for treating recovered paper suspensions and is known to be particularly at risk for wear. Wire 11, which is provided with a number of bars 12, is shown only in part for ease of illustration and explanation. The illustration in FIG. 1 is shown from a view direction that is from the side on which a scraper (not shown) is arranged. Wire openings 13 of wire 11 are shown only in part. Usually the wire is used to pass the already slushed or deflaked part of the paper stock, whereas not yet sufficiently slushed paper shreds and larger contaminants are rejected. The contaminants, such as metal parts, sand, stones or broken glass, sliding past wire 11 thereby lead to a very high degree of wear that impacts in particular screwed on bars 12. Even if they are made of a wear-resistant material, replacing them at certain intervals is useful. Screws 14 that are used for the releasable attachment of bars 12 are each equipped with a turned part in which at least two recesses are made, though this is not more clearly discernible until the following Figures. Screws 14 can either be screwed into wire 11 and/or into a support framework 15, which is located under wire 11 and belongs to the slushing device. Screws 16 with which wire 11 is attached to support framework 15 are represented as conventional screws here, but they could also be selected according to the present patent claims in order to facilitate the replacement of wire 11. Wire 11 is ring-shaped or composed of ring segments.

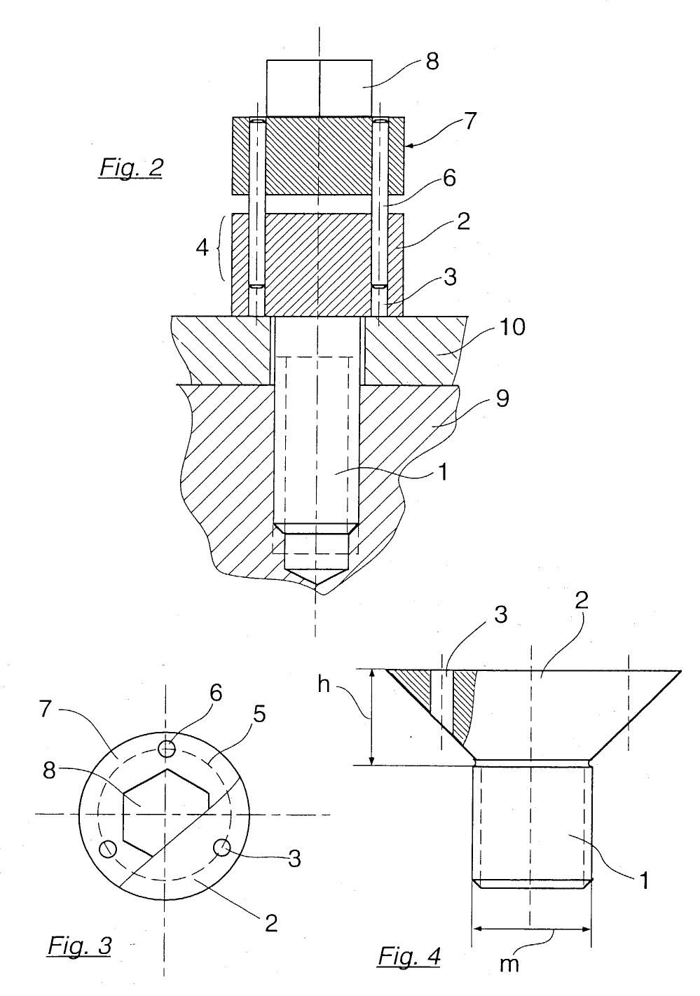

The example in FIG. 2 shows a screw element that is embodied as a screw fastener. Two machine parts 9 and 10 are thereby releasably screwed together, which would generally would correspond to bars 12 and wire 11 in FIG. 1. The screw element contains a threaded part 1 and a turned part 2 which is provided with laterally spaced recesses 3, which are, e.g., embodied or formed as continuous bores arranged in a parallel manner. Their lengthwise extension lies in the direction of the screw infeed, i.e., vertically in this drawing. A torsional moment can easily be transmitted due to this position. A removable connecting part 7 with projecting pins 6 is used to operate this screw element, which pins are arranged and sized such that they fit into recesses 3 of turned part 2. Moreover, connecting part 7 bears a locking profile 8, here an external hexagonal profile, which can be turned with a spanner in the usual way. Naturally, connecting part 7 can also feature a lever with which the mechanic can apply the torsional moment. In this case, a locking profile can be dispensed with.

As already stated, the screw element is suitable to be loosened or tightened even if wear has occurred. To this end, it can feature a material surplus 4 that is to be considered a wear reserve. This means that, even when this material surplus has been worn off, it is still possible to loosen or tighten the screw by inserting connecting part 7. Both connecting part 7 and turned part 2 can be seen, in part, in FIG. 3, since a cutaway view of connecting part 7 is depicted. An arrangement of recesses 3 or pins 6 on a circle 5 is discernible here, which circle is concentric to the center of the screw. The recesses are arranged uniformly with respect to one another, i.e., at equal angular distances from one another.

With many screw connections it is desirable for the screw fastener to be provided with a head that can be countersunk. FIG. 4 shows such an example. In this case, the invention can be practiced by providing a screw head, i.e., turned part 2, with a number of recesses 3, in particular, continuous cylinder bores. The axial extension of turned part 2, i.e., head height h, is at least approximately 0.8 thereby significantly higher with respect to the thread diameter m than with comparable standard parts. According to DIN 87, flat-head screws with m=10 mm have a corresponding value of 0.55 and according to DIN 63 a value of 0.34. Even if countersunk screws do not project in the installed condition, they are nevertheless subjected to a substantial wear that leads to abrasions, thus erodes the wear reserve of such a screw.

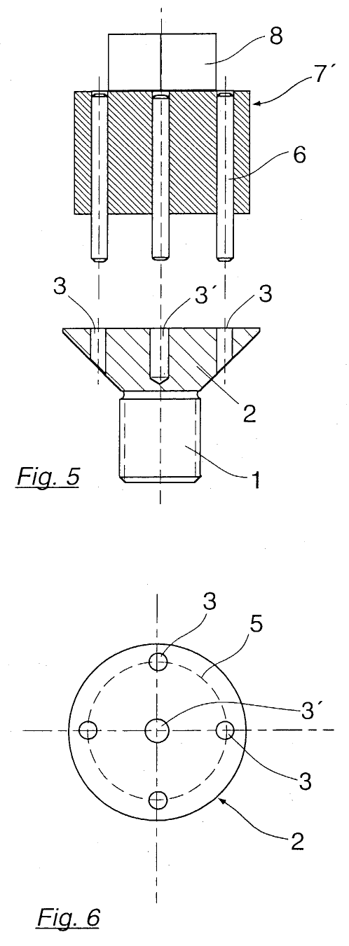

It is advantageous in many cases to select the number of recesses to be higher than three in order to be able to distribute the necessary torsional moment to more pins. In the example according to FIGS. 5 and 6, a flat-head screw is shown that features a central recess 3′ and four further recesses 3 outside the center. The connecting part 7′ is adjusted accordingly.

As is known, there are also screw connections in which at least one nut is screwed and tightened or loosened on a fixed, i.e., not rotatable, threaded bolt. It goes without saying that the invention can also be used with such screw connections, e.g., by providing the nut with the referenced recesses or bores on its face.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A process for the releasable attachment of wearing parts in devices for treating suspended fiber stock using screw elements with at least one threaded part and at least one turned part, the process comprising:
transmitting a torsional force to the at least one turned part, which includes at least two recesses, which is sufficient to one of tighten or loosen the threaded part,
wherein the at least two recesses are sunk in a same direction as a screw in feed of the threaded part.

2. The process in accordance with claim 1, wherein the suspended fiber stock being treated is recovered paper.

3. The process in accordance with claim 1, wherein at least three recesses are sunk in the turned part.

4. The process in accordance with claim 1, wherein a free cross section of the recesses is constant across at least 90% of a lengthwise extension of the recesses.

5. The process in accordance with claim 4, wherein the at least two recesses completely penetrate the turned part.

6. The process in accordance with claim 1, wherein the at least two recesses are cylindrical bores arranged in a parallel manner.

7. The process in accordance with claim 1, wherein the at least two recesses comprise a recess located in a center of the turned part and a recess not located in the center of the turned part.

8. The process in accordance with claim 1, wherein the at least two recesses comprise at least three recesses which are uniformly arranged on a circle lying concentric with the threaded part.

9. The process in accordance with claim 1, wherein the at least one threaded element comprises a screw fastener and the turned part comprises a screw head.

10. The process in accordance with claim 1, wherein the at least one turned part comprises a nut having a face in which the at least two recesses are sunk.

11. The process in accordance with claim 1, further comprising machining one of a screw head or a face of a nut with the at least two recesses.

12. The process in accordance with claim 1, wherein the turned part has a material surplus serving as a wear reserve, through which the at least two recesses extend.

13. The process in accordance with claim 12, wherein the material surplus is produced such that an axial extension of the turned part is significantly larger with respect to the thread diameter than with corresponding standard parts.

14. The process in accordance with claim 13, wherein a ratio of the axial extension of the turned part to the thread diameter is at least 0.6.

15. The process in accordance with claim 14, wherein the ratio is at least 0.8.

16. The process in accordance with claim 1, wherein the transmitting of torsional force comprises coupling a connecting part to the at least one turned part.

17. The process in accordance with claim 16, wherein the connecting part comprises at least two projections or pins structured and arranged to fit into the at least two recesses, and the transmission of torsional force further comprises inserting the at least two projections or pins into the at least two recesses and applying a torque to the connecting part, whereby the turned part rotates.

18. The process in accordance with claim 17, wherein the connecting part further includes a locking profile structured and arranged to receive a screw turning tool, and the transmission of torsional force further comprises coupling the screw turning tool to the locking profile and rotating the locking profile via the screw turning tool.

19. The process in accordance with claim 17, wherein the connecting part further includes a locking profile structured and arranged to receive a lever, and the transmission of torsional force further comprises coupling the lever to the locking profile and rotating the locking profile via the lever.

20. The process in accordance with claim 1, wherein the device for treating suspended fiber stock comprises a pulper for recovered paper pulper.

21. The process in accordance with claim 1, wherein the device for treating suspended fiber stock comprises a secondary pulper connected downstream of a recovered paper pulper.

22. The process in accordance with claim 1, wherein the device for treating suspended fiber stock comprises a screen for contaminated recovered paper suspension.

23. An apparatus for releasably attaching wearing parts in devices for treating suspended fiber stock, the apparatus comprising:
at least one threaded part having a longitudinal axis; and
at least one turned part comprising at least two recesses that are sunk in a same direction as the longitudinal axis of the threaded part.

24. The apparatus in accordance with claim 23, wherein said at least two recesses comprise at least three recesses sunk in said turned part.

25. The apparatus in accordance with claim 23, wherein a free cross section of said at least two recesses is constant across at least 90% of a lengthwise extension of said at least two recesses.

26. The apparatus in accordance with claim 25, wherein said at least two recesses completely penetrate said turned part.

27. The apparatus in accordance with claim 23, wherein said at least two recesses comprise a recess located in a center of said turned part and a recess not located in the center of said turned part.

28. The apparatus in accordance with claim 23, wherein said at least two recesses comprise at least three recesses which are uniformly arranged on a circle lying concentric with said threaded part.

29. The apparatus in accordance with claim 23, wherein said at least one turned part comprises a nut having a face in which the at least two recesses are sunk.

30. The apparatus in accordance with claim 23, wherein said turned part has a material surplus serving as a wear reserve, through which said at least two recesses extend.

31. The apparatus in accordance with claim 30, wherein a ratio of an axial extension of said turned part to a thread diameter of said threaded part is at least 0.6.

32. The apparatus in accordance with claim 13, wherein the ratio is at least 0.8.

33. The apparatus in accordance with claim 23, further comprising a connecting part structured and arranged to be coupled to said at least one turned part to transmit a torsional force to said at least one turned part.

34. The apparatus in accordance with claim 33, wherein said connecting part comprises at least two projections or pins structured and arranged to fit into said at least two recesses.

35. The apparatus in accordance with claim 34, wherein said connecting part further comprises a locking profile structured and arranged to receive a screw turning tool, whereby a torsional force is transmitted to said at least one turning part via said screw turning tool.

36. The apparatus in accordance with claim 34, wherein said connecting part further includes a locking profile structured and arranged to receive a lever, whereby a torsional force is transmitted to said at least one turning part via said lever.

37. An apparatus for treating suspended fiber stock, comprising:
a wire structured and arranged to pass treated stock;
bars coupled to said wires; and
a connection element structured and arranged to releasably attach said bars to said wire, said connection element having a longitudinal axis and a head having at least two recesses sunk in a same direction as the longitudinal axis.

38. The apparatus in accordance with claim 37, wherein said apparatus is structured and arranged for treating suspended fiber stock as a pulper for recovered paper pulper.

39. The apparatus in accordance with claim 37, wherein said apparatus is structured and arranged for treating suspended fiber stock as a secondary pulper connected downstream of a recovered paper pulper.

40. The apparatus in accordance with claim 37, wherein said apparatus is structured and arranged for treating suspended fiber stock for contaminated recovered paper suspension.

41. The apparatus in accordance with claim 37, wherein said head is mounted flush with a surface of said bars.

42. The apparatus in accordance with claim 37, wherein said head is structured to project from a surface of said bars.
